(19) United States
(12) Patent Application Publication
(10) Pub. No.: US 2017/0250960 A1
(43) Pub. Date: Aug. 31, 2017

(54) INFORMATION SHARING METHOD, SYSTEM AND DEVICE AND COMPUTER STORAGE MEDIUM

(71) Applicant: ZTE CORPORATION, Shenzhen City (CN)

(72) Inventors: Jin ZHAO, Shenzhen City (CN); Xiaoyong ZHANG, Shenzhen City (CN)

(73) Assignee: ZTE CORPORATION, Shenzhen City (CN)

(21) Appl. No.: 15/321,162

(22) PCT Filed: Oct. 11, 2014
(86) PCT No.: PCT/CN2014/088385

§ 371 Date: Apr. 26, 2017

(30) Foreign Application Priority Data
Jun. 23, 2014 (CN) 201410283551.3

(51) Int. Cl. H04L 29/06; H04L 29/12

(52) U.S. Cl. CPC H04L 63/0428; H04L 61/157; H04L 67/42

(57) ABSTRACT

An information sharing method, device and system, and a computer storage medium are described. The method includes: a server receiving user information change data and determining information change content; inquiring at least one pre-stored group according to the information change content, determining that a group corresponding to the information change content exists, and obtaining information about a target object of the group; and sending the information change content is sent to the target object.

### CROSS-REFERENCE TO RELATED APPLICATION

This application is the U.S. national phase of PCT Application No. PCT/CN2014/088385 filed Oct. 11, 2014, which claims priority to Chinese Application No. 201410283551.3 filed Jun. 23, 2014, the disclosures of which are incorporated in their entirety by reference herein.

### TECHNICAL FIELD

The present document relates to an information sharing technology, and particularly to an information sharing method, system and device, and a computer storage medium.

### BACKGROUND

The quantity of information for interacting between users via mobile terminals is increasing. Usually, a contact list of each user may contain hundreds of pieces of information. When a personal communication mode of a user changes, e.g., a phone number is changed, the user has to inform related contacts of changed contact information of the user itself one by one. This manner wastes both time and labor.

As for the abovementioned problem, there is no effective solution existing in the related technology.

### SUMMARY

In order to solve the existing technical problem, embodiments of the present document provides an information sharing method, system and device, and a computer storage medium, which can realize automatically informing related contacts of changed user information.

To this end, the technical solution in the embodiments of the present document is implemented as follows.

An embodiment of the present document provides an information sharing method which is applied to a server and includes:

receiving, by a server, user information change data, and determining information change content;

inquiring at least one pre-stored group according to the information change content, determining that a group corresponding to the information change content exists, and obtaining information about a target object of the group; and

sending the information change content to the target object.

In a further embodiment, before the server receives the user information change data, the method further includes:

receiving information data synchronized by a client; herein, the information data includes at least one piece of group data, and each piece of group data includes a mapping relation between user information categories corresponding to a group and target objects, and a key corresponding to each target object.

In a further embodiment, the step of sending the information change content to the target object includes:

sending information change content encrypted by using a key corresponding to the target object to the target object.

In a further embodiment, the step of inquiring the pre-stored group according to the information change content and determining that the group corresponding to the information change content exists includes:

determining a corresponding user information category according to the information change content, inquiring at least one piece of group data according to the user information category, and determining a group corresponding to the user information category.

In a further embodiment, when it is determined that there is no group corresponding to the information change content, the method further includes:

sending prompt information to the client, herein the prompt information is used for representing that there is no group corresponding to the information change content; and

receiving a response message sent by the client, and not executing any operation according to the response message; or, re-determining whether a group corresponding to the information change content exists according to information data carried in the response message.

An embodiment of the present document also provides an information sharing method which is applied to a client and includes:

detecting, by a client, that user information is updated, and acquiring information change content; and

sending user information change data to a server, herein the user information change data includes the information change content.

In a further embodiment, before the client detects that the user information is updated, the method further includes:

sending, by the client, according to at least one pre-stored group, a request message corresponding to the group to a target object in the at least one group, herein the request message is used for obtaining confirmation of the target object; and

receiving a confirmation message sent by the target object, herein the confirmation message includes a key corresponding to the target object.

In a further embodiment, before the client detects that the user information is updated, the method further includes:

synchronizing, by the client, information data to the server; herein the information data includes at least one piece of group data, and each piece of group data includes a mapping relation between user information categories corresponding to a group and target objects, and a key corresponding to each target object.

In a further embodiment, the method further includes:

receiving, by the client, prompt information; herein the prompt information is used for representing that there is no group corresponding to the information change content in the server; and

creating a group corresponding to the information change content according to a user operation, and sending a response message to the server, herein the response message includes group data corresponding to the information change content; or, sending a response message to the server, herein the response message is used for indicating not executing any operation.

An embodiment of the present document also provides an information sharing method which includes:

detecting, by a client, that user information is updated, acquiring information change content, and sending user information change data to a server; herein the user information change data includes the information change content; and

receiving, by the server, the user information change data, determining the information change content; inquiring at least one pre-stored group according to the information change content, determining that a group corresponding to the information change content exists, obtaining information about a target object of the group; and sending the information change content to the target object.

An embodiment of the present document also provides a server, which includes: a first communication unit, a mapping unit and a pushing unit; herein, the first communication unit is arranged to receive user information change data, and send the user information change data to the mapping unit;

the mapping unit is arranged to determine information change content according to the user information change data sent by the first communication unit, inquire at least one pre-stored group according to the information change content, determine that a group corresponding to the information change content exists, and obtain information about a target object of the group; and

the pushing unit is arranged to send the determined information change content to the target object obtained by the mapping unit.

In a further embodiment, the first communication unit is further arranged to receive information data synchronized by a client before receiving the user information change data; herein, the information data includes at least one piece of group data, and each piece of group data includes a mapping relation between user information categories corresponding to a group and target objects, and a key corresponding to each target object; and the mapping unit is further arranged to store the information data received by the first communication unit.

In a further embodiment, the pushing unit is arranged to send information change content encrypted by using a key corresponding to the target object to the target object obtained by the mapping unit.

In a further embodiment, the mapping unit is arranged to determine a corresponding user information category according to the information change content, inquire at least one piece of group data according to the user information category, and determine a group corresponding to the user information category.

In a further embodiment, the first communication unit is further arranged to: send prompt information to the client when the mapping unit determines that there is no group corresponding to the information change content, herein the prompt information is used for representing that there is no group corresponding to the information change content; and receive a response message sent by the client; and

the mapping unit is further arranged to not execute any operation according to the response message received by the first communication unit; or, re-determine whether a group corresponding to the information change content exists according to information data carried in the response message received by the first communication unit.

An embodiment of the present document also provides a client, which includes: a detection unit and a second communication unit; herein

the detection unit is arranged to detect that user information is updated, and acquire information change content; and

the second communication unit is arranged to send user information change data to a server, herein the user information change data includes the information change content acquired by the detection unit.

In a further embodiment, the second communication unit is further arranged to: send a request message corresponding to the group to a target object in the at least one group according to at least one pre-stored group, herein the request message is used for obtaining confirmation of the target object; and, is further arranged to receive a confirmation message sent by the target object, herein the confirmation message includes a key corresponding to the target object.

In a further embodiment, the second communication unit is further arranged to synchronize information data to the server before detecting that the user information is updated; herein the information data includes at least one piece of group data, and each piece of group data includes a mapping relation between user information categories corresponding to a group and target objects, and a key corresponding to each target object.

In a further embodiment, the client further includes an operation processing unit, herein, the second communication unit is further arranged to: receive prompt information, herein the prompt information is used for representing that there is no group corresponding to the information change content in the server; and, is further arranged to send a response message to the server; and

the operation processing unit is arranged to: create a group corresponding to the information change content according to a user operation, and trigger the second communication unit to send the response message to the server, herein the response message includes group data corresponding to the information change content; or, is arranged to trigger the second communication unit to send the response message to the server, herein the response message is used for indicating not executing any operation.

An embodiment of the present document also provides an information sharing system, which includes: a client and a server; herein,

the client is arranged to detect that user information is updated, acquire information change content, and send user information change data to the server; herein, the user information change data includes the information change content; and

the server is arranged to receive the user information change data, determine the information change content, inquire at least one pre-stored group according to the information change content, determine that a group corresponding to the information change content exists, obtain information about a target object of the group, and send the information change content to the target object.

In a further embodiment, the client is further arranged to: send a request message corresponding to the group to the target object in the at least one group according to the at least one pre-stored group before detecting that the user information is updated, herein the request message is used for obtaining confirmation of the target object; and receive a confirmation message sent by the target object, herein the confirmation message includes a key corresponding to the target object.

In a further embodiment, the client is further arranged to synchronize information data to the server before detecting that the user information is updated; herein the information data includes at least one piece of group data, and each piece of group data includes a mapping relation between user information categories corresponding to a group and target objects, and a key corresponding to each target object; and

the server is further arranged to receive the information data synchronized by the client before receiving the user information change data.

In a further embodiment, the server is further arranged to send information change content encrypted by using the key corresponding to the target object to the target object.

In a further embodiment, the server is further arranged to determine a corresponding user information category according to the information change content, inquire at least one piece of group data according to the user information category, and determine a group corresponding to the user information category.

In a further embodiment, the server is further arranged to: send prompt information to the client when determining that there is no group corresponding to the information change content, herein the prompt information is used for representing that there is no group corresponding to the information change content; and, is also arranged to receive a response message sent by the client, and not execute any operation according to the response message; or, re-determine whether a group corresponding to the information change content exists according to information data carried in the response message; and

the client is further arranged to receive the prompt information sent by the server; and further arranged to: create the group corresponding to the information change content according to a user operation, and send the response message to the server, herein the response message includes group data corresponding to the information change content; or, send the response message to the server, herein the response message is used for indicating not executing any operation.

The embodiment of the present document also provides a computer storage medium, storing computer-executable instructions, herein the computer-executable instructions are used for executing the information sharing method applied to the server according to the embodiments of the present document.

The embodiment of the present document also provides a computer storage medium, storing computer-executable instructions, herein the computer-executable instructions are used for executing the information sharing method applied to the client according to the embodiments of the present document.

According to the information sharing method, system and device, and the computer storage medium provided by the embodiments of the present document, the server receives the user information change data, and determines the information change content; inquires at least one pre-stored group according to the information change content, determines that the group corresponding to the information change content exists, and obtains information about the target object of the group; and sends the information change content to the target object. Thus, related contacts may be automatically informed of changed user information without being informed one by one, thereby saving both time and labor and greatly improving the user experience.

### BRIEF DESCRIPTION OF DRAWINGS

FIG. 1 is a flowchart of an information sharing method according to an embodiment one of the present document.

FIG. 2 is a flowchart of an information sharing method according to an embodiment two of the present document.

FIG. 3 is a flowchart of an information sharing method according to an embodiment three of the present document.

FIG. 4 is a flowchart of an information sharing method according to an embodiment four of the present document.

FIG. 5 is a schematic diagram of a composition structure of a server according to an embodiment of the present document.

FIG. 6 is a schematic diagram of a composition structure of a client according to an embodiment of the present document.

FIG. 7 is a schematic diagram of a composition structure of an information sharing system according to an embodiment of the present document.

### DETAILED DESCRIPTION

The present document will be further elaborated below in conjunction with accompanying drawings and specific embodiments.

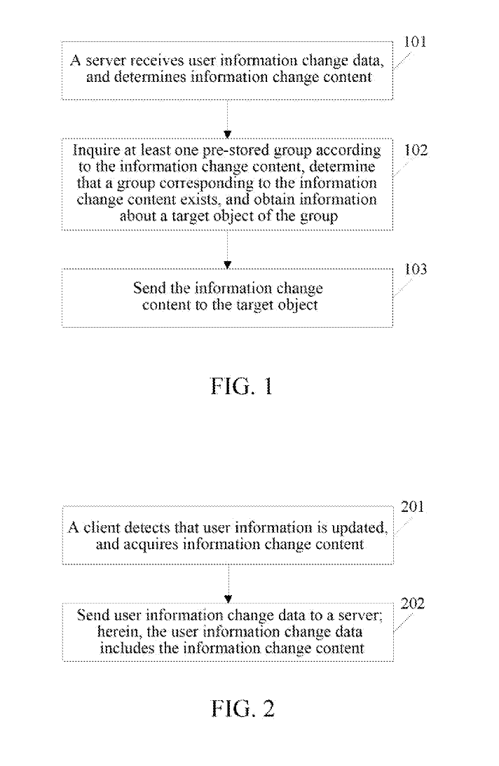

An embodiment of the present document provides an information sharing method. The information sharing method is applied to a server. FIG. 1 is a flowchart of an information sharing method according to an embodiment one of the present document. As shown in FIG. 1, the method includes the following steps.

Step 101: The server receives user information change data and determines information change content.

Here, before the server receives the user information change data, the method further includes: receiving information data synchronized by a client; herein the information data includes at least one piece of group data, and each piece of group data includes a mapping relation between user information categories corresponding to a group and target objects, and a key corresponding to each target object.

Specifically, the group data includes a mapping relation between user information categories corresponding to a group and target objects, the user information categories are, for example, a phone number, a conference and a schedule, namely a phone number update followed group, a conference reminder update followed group, and a schedule reminder update followed group, etc.

Herein, the key corresponding to the target object is generated by the target object and sent to the client when the client sends a confirmation to the target object, and is sent to the server when the client synchronizes information data.

Step 102: At least one pre-stored group is inquired according to the information change content, it is determined that a group corresponding to the information change content exists, and information about a target object of the group is obtained.

Here, the step that the pre-stored group is inquired according to the information change content and it is determined that the group corresponding to the information change content exists includes that: a corresponding user information category is determined according to the information change content, at least one piece of group data is inquired according to the user information category, and a group corresponding to the user information category is determined.

Specifically, the at least one group includes: a phone number group, a conference group, a schedule group and other groups, namely the phone number update followed group, the conference reminder update followed group and the schedule reminder update followed group, etc. When the information change content is a phone number, the user information category corresponding to the information change content is identified, such as, the phone number, then group names of the abovementioned three stored groups are searched for obtaining the group name matched with the phone number, namely the phone number update followed group. Further, information about all target objects in the phone number update followed group is acquired, and the information about the target objects is contact information of the target objects, such as phone numbers and e-mail addresses, etc.

According to a further alternative embodiment of the present document, when it is determined that there is no group corresponding to the information change content, the method further includes the following steps.

Prompt information is sent to the client, the prompt information is used for representing that there is no group corresponding to the information change content;

A response message sent by the client is received, and any operation is not executed according to the response message. Or, it is re-determined whether the group corresponding to the information change content exists according to information data carried in the response message.

Specifically, when it is determined that there is no group corresponding to the information change content, the server sends prompt information to the client, the prompt information is used for prompting a user that there is no the group corresponding to the information change content. The server inquires whether to create the group corresponding to the information change content, creates the group corresponding to the information change content according to a user operation, and further executes the above-mentioned synchronization of the information data. Or, the server does not create the group corresponding to the information change content, so as to abandon information sharing.

Step 103: The information change content is sent to the target object.

Here, the step that the information change content is sent to the target object includes that: the information change content encrypted by using the key corresponding to the target object is sent to the target object.

Specifically, the server encrypts the information change content by using the key corresponding to the target object, and sends the encrypted information change content to the target object, and the target object self-decrypts to obtain the information change content, so as to avoid leakage of personal information caused by wrong sending of the information change content to a wrong target object.

In the present embodiment, different sharing rights are granted to different groups. That is, as for the phone number update followed group, when the phone number of the user changes, the changing phone number is sent to the target object in the corresponding group; as for the conference reminder update followed group, when the user changes a conference schedule, the changed conference progress is sent to the target object in the corresponding group; and as for the schedule reminder update followed group, when the user changes a schedule, the changed schedule progress is sent to the target object in the corresponding group. Thus, related contacts may be automatically informed of changed user information without being informed one by one, thereby saving both time and labor, and greatly improving the user experience.

The embodiment of the present document also provides a computer storage medium, in which computer-executable instructions are stored. The computer-executable instructions are used for executing the information sharing method applied to the server according to the embodiment of the present document.

An embodiment of the present document provides an information sharing method. The information sharing method is applied to a client. FIG. 2 is a flowchart of an information sharing method according to an embodiment two of the present document. As shown in FIG. 2, the method includes the following steps.

Step 201: The client detects that user information is updated, and acquires information change content.

Here, before the client detects that the user information is updated, the method further includes the following steps.

The client sends, according to at least one pre-stored group, a request message corresponding to the group to a target object in the at least one group, herein the request message is used for obtaining confirmation of the target object.

A confirmation message sent by the target object is received, the confirmation message includes a key corresponding to the target object.

Specifically, after the client sends a request message to the target object, the target object confirms the request message and generates a key, the key contained in a confirmation message is returned to the client, and the target object stores the key, in order to decrypt the encrypted information change content when shared information is received, so as to avoid leakage of personal information caused by sending of the information change content to a wrong target object; herein the keys generated by the target objects in various groups may be identical or may be different from each other.

Here, before the client detects that the user information is updated, the method further includes that: the client synchronizes information data to the server; herein the information data includes at least one piece of group data, and each piece of group data includes a mapping relation between user information categories corresponding to a group and target objects, and a key corresponding to each target object.

Herein, the key is arranged to encrypt the information change content when the server sends the information change content to the target object, so as to avoid leakage of personal information caused by wrong sending of the information change content to a wrong target object.

Step 202: User information change data is sent to a server; herein the user information change data includes the information change content.

In the present embodiment, the server determines that a group corresponding to the information change content exists, and when the server determines that there is no group corresponding to the information change content, the method further includes the following steps.

The client receives prompt information; the prompt information is used for representing that there is no group corresponding to the information change content in the server.

The group corresponding to the information change content is created according to a user operation, and a response message is sent to the server, the response message includes group data corresponding to the information change content. Or, a response message is sent to the server, the response message is used for indicating not executing any operation.

Specifically, the client creates the group corresponding to the information change content according to the prompt information, and further synchronizes the group information data to the server; or, the client does not creates the group corresponding to the information change content according to the prompt information, so as to abandon information sharing.

In the present embodiment, different sharing rights are granted to different groups. That is, as for the phone number update followed group, when the phone number of the user changes, the changed phone number is sent to the target object in the corresponding group. As for the conference reminder update followed group, when the user changes a conference schedule, the changed conference progress is sent to the target object in the corresponding group. As for the schedule reminder update followed group, when the user changes a schedule, the changed schedule progress is sent to the target object in the corresponding group. Thus, related contacts may be automatically informed of changed user information without being informed one by one, thereby saving both time and labor, and greatly improving the user experience.

The embodiment of the present document also provides a computer storage medium, in which computer-executable instructions are stored. The computer-executable instructions are used for executing the information sharing method applied to the client according to the embodiment of the present document.

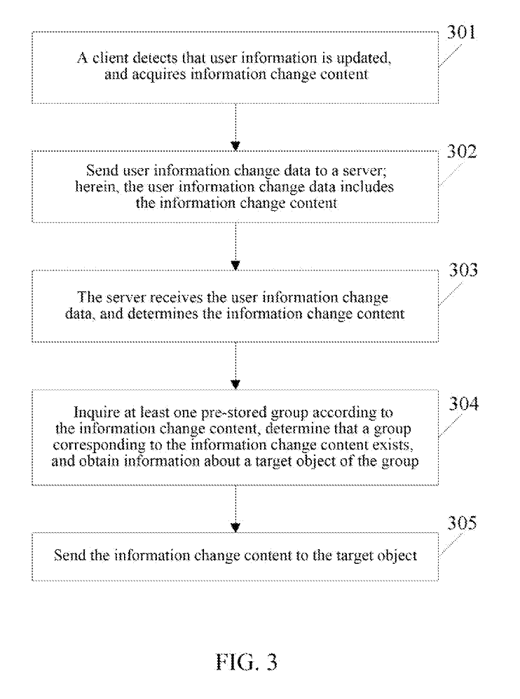

An embodiment of the present document provides an information sharing method. FIG. 3 is a flowchart of an information sharing method according to an embodiment three of the present document. As shown in FIG. 3, the method includes the following steps.

Step 301: A client detects that user information is updated, and acquires information change content.

Here, before the client detects that the user information is updated, the method further includes the following steps: the client sends, according to at least one pre-stored group, a request message corresponding to the group to a target object in the at least one group, herein the request message is used for obtaining confirmation of the target object; receives a confirmation message sent by the target object, the confirmation message includes a key corresponding to the target object.

Specifically, after the client sends a request message to the target object, the target object confirms the request message and generates a key, the key contained in a confirmation message is returned to the client, and the target object stores the key, in order to decrypt the encrypted information change content when shared information is received, so as to avoid leakage of personal information caused by sending of the information change content to a wrong target object; herein the keys generated by the target objects in various groups may be identical or may be different from each other.

Here, before the client detects that the user information is updated, the method further includes that: the client synchronizes information data to a server; herein the information data includes at least one piece of group data, and each piece of group data includes a mapping relation between user information categories corresponding to a group and target objects, and a key corresponding to each target object.

Herein, the key is arranged to encrypt the information change content when the server sends the information change content to the target object, so as to avoid leakage of personal information caused by wrong sending of the information change content to a wrong target object.

Step 302: User information change data is sent to a server; herein the user information change data includes the information change content.

Step 303: The server receives the user information change data, and determines the information change content.

Here, before the server receives the user information change data, the method further includes: receiving information data synchronized by the client; herein the information data includes at least one piece of group data, and each piece of group data includes a mapping relation between user information categories corresponding to a group and target objects, and a key corresponding to each target object.

Specifically, the group data includes a mapping relation between user information categories corresponding to a group and target objects, the user information categories are, for example, a phone number, a conference and a schedule, etc. namely a phone number update followed group, a conference reminder update followed group, and a schedule reminder update followed group.

Herein, the key corresponding to the target object is generated by the target object and sent to the client when the client sends a confirmation to the target object, and is sent to the server when the client synchronizes information data.

Step 304: At least one pre-stored group is inquired according to the information change content, it is determined that a group corresponding to the information change content exists, and information about a target object of the group is obtained.

Here, the step that the pre-stored group is inquired according to the information change content and it is determined that the group corresponding to the information change content exists includes that:

a corresponding user information category is determined according to the information change content, at least one piece of group data is inquired according to the user information category, and a group corresponding to the user information category is determined.

Specifically, the at least one group includes: a phone number group, a conference group, a schedule group and other groups, etc., namely the phone number update followed group, the conference reminder update followed group and the schedule reminder update followed group. When the information change content is a phone number, the user information category corresponding to the information change content is identified, such as, the phone number, then group names of the abovementioned three stored groups are searched for obtaining the group name matched with the phone number, namely the phone number update followed group. Further, information about all target objects in the phone number update followed group is acquired, the information about the target objects is contact information of the target objects, such as phone numbers and e-mail addresses, etc.

Step 305: The information change content is sent to the target object.

Here, the step that the information change content is sent to the target object includes that:

the information change content encrypted by using the key corresponding to the target object is sent to the target object.

Specifically, the server encrypts the information change content by using the key corresponding to the target object, and sends the encrypted information change content to the target object, and the target object self-decrypts to obtain the information change content, so as to avoid leakage of personal information caused by wrong sending of the information change content to a wrong target object.

According to a further alternative embodiment of the present document, when it is determined that there is no group corresponding to the information change content, the method further includes the following steps.

Prompt information is sent to the client; the prompt information is used for representing that there is no group corresponding to the information change content.

A response message sent by the client is received, and any operation is not executed according to the response message. Or, it is re-determined whether the group corresponding to the information change content exists according to information data carried in the response message.

Specifically, when it is determined that there is no group corresponding to the information change content, the server sends prompt information to the client, the prompt information is used for prompting a user that there is no the group corresponding to the information change content, and the server inquires whether to create the group corresponding to the information change content, creates the group corresponding to the information change content according to a user operation, and further executes the above-mentioned synchronization of the information data; or the server does not create the group corresponding to the information change content, so as to abandon information sharing.

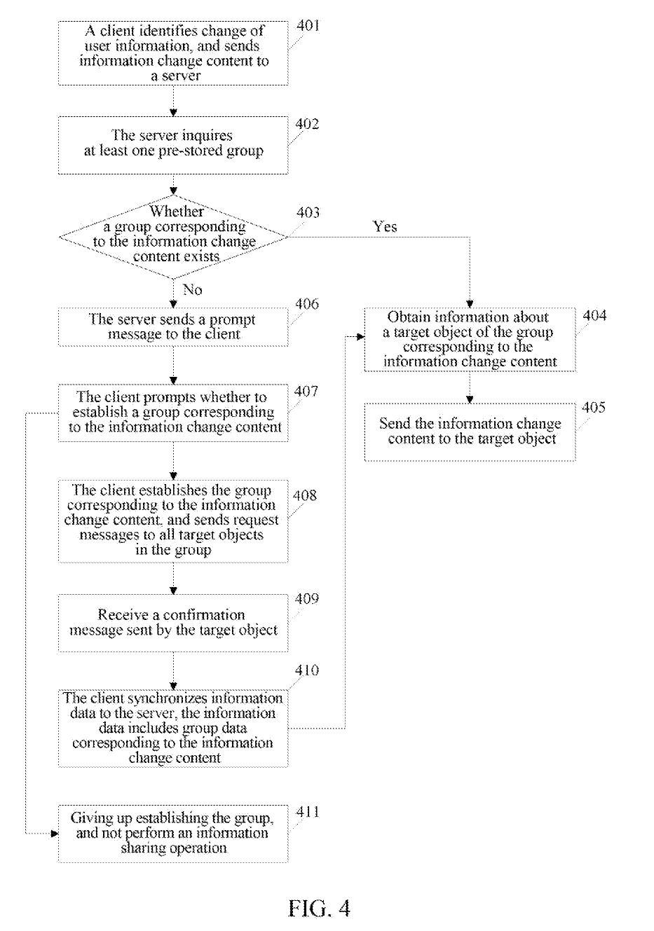

An embodiment of the present document provides an information sharing method. FIG. 4 is a flowchart of an information sharing method according to an embodiment four of the present document. As shown in FIG. 4, the method includes the following steps.

Step 401: A client identifies change of user information, and sends information change content to a server.

In the present embodiment, adoption of the information change content as a phone number of a user is taken as an example. That is, change of the phone number is identified, and the changed phone number is sent to the server.

Step 402: The server inquires at least one pre-stored group.

Specifically, the at least one group includes: a phone number group, a conference group, a schedule group and other groups, etc., namely a phone number update followed group, a conference reminder update followed group and a schedule reminder update followed group. When the information change content is a phone number, the user information category corresponding to the information change content is identified, such as, the phone number, then group names of the abovementioned three stored groups are searched for obtaining the group name matched with the phone number, namely the phone number update followed group.

Step 403: It is judged whether a group corresponding to the information change content exists, when a judgment result is yes, Step 404 is executed, and when a judgment result is no, Step 406 is executed.

Step 404: Information about a target object of the group corresponding to the information change content is obtained, and Step 405 is executed.

Here, a group corresponding to the phone number category is determined, and information about all target objects in the group is acquired, the information about the target objects is contact information of the target objects, such as phone numbers and e-mail addresses, etc.

Step 405: The information change content is sent to the target object.

In the present embodiment, the server sends the changed phone number to the target object.

Step 406: The server sends a prompt message to the client; the prompt message is used for representing that there is no group corresponding to the information change content.

Here, when the server determines that there is no group corresponding to the information change content, the prompt information is sent to the client.

Step 407: The client prompts whether to establish the group corresponding to the information change content, when the group corresponding to the information change content is established, Step 408 is executed; when the group corresponding to the information change content is not established, Step 411 of giving up establishing the group and not performing an information sharing operation are executed.

Step 408: The client establishes the group corresponding to the information change content, and sends request messages to all target objects in the group; herein the request messages are used for obtaining confirmation of the target objects.

Here, the client may establish the group corresponding to the information change content according to a user operation, i.e., the phone number update followed group. The client sends confirmation messages to all target objects in the phone number update followed group so as to be confirmed by the target object.

Step 409: A confirmation message sent by the target object is received, so as to complete confirmation of the target object.

Here, the target object gives a confirmation according to the request message sent by the client and generates a key, the key contained in a confirmation message is returned to the client, and the target object stores the key, in order that the encrypted information change content is decrypted when shared information is received, so as to avoid leakage of personal information caused by wrong sending of the information change content to a wrong target object; herein the keys generated by the target objects in all groups may be identical or may be different from each other.

Step 410: The client synchronizes information data to the server, the information data includes group data corresponding to the information change content. Step 404 and Step 405 are further executed.

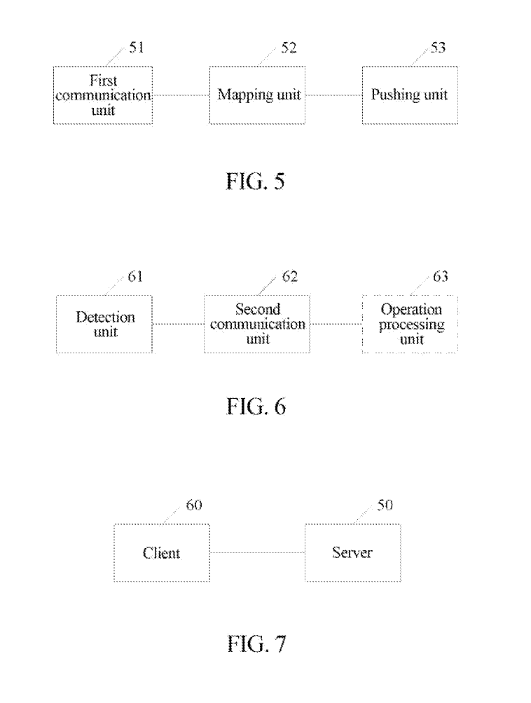

An embodiment of the present document also provides a server. FIG. 5 is a schematic diagram of a composition structure of a server according to an embodiment of the present document. As shown in FIG. 5, the server includes: a first communication unit 51, a mapping unit 52 and a pushing unit 53.

The first communication unit 51 is arranged to receive user information change data and send the user information change data to the mapping unit 52;

The mapping unit 52 is arranged to determine information change content according to the user information change data sent by the first communication unit 51, inquire at least one pre-stored group according to the information change content, determine that a group corresponding to the information change content exists, and obtain information about a target object of the group.

The pushing unit 53 is arranged to send the determined information change content to the target object obtained by the mapping unit 52.

Herein, the mapping unit 52 is arranged to determine a corresponding user information category according to the information change content, inquire at least one piece of group data according to the user information category, and determine a group corresponding to the user information category.

According to a further alternative embodiment of the present document, the first communication unit 51 is further arranged to receive information data synchronized by a client before receiving the user information change data; herein the information data includes at least one piece of group data, and each piece of group data includes a mapping relation between user information categories corresponding to a group and target objects, and a key corresponding to each target object.

The mapping unit 52 is further arranged to store the information data received by the first communication unit 51.

According to a further alternative embodiment of the present document, the pushing unit 53 is arranged to send information change content encrypted by using a key corresponding to the target object to the target object obtained by the mapping unit 52.

According to a further alternative embodiment of the present document, the first communication unit 51 is further arranged to: send prompt information to the client when the mapping unit 52 determines that there is no group corresponding to the information change content, the prompt information is used for representing that there is no group corresponding to the information change content; and receive a response message sent by the client.

The mapping unit 52 is further arranged to not execute any operation according to the response message received by the first communication unit 51; or, re-determine whether the group corresponding to the information change content exists according to information data carried in the response message received by the first communication unit 51.

Those skilled in the art shall understand that functions of each processing unit in the server of the embodiment of the present document may be interpreted with reference to related descriptions for the above-mentioned information sharing method. Each processing unit in the server of the embodiment of the present document may be implemented by means of an analog circuit for achieving the functions in the embodiment of the present document, or may be implemented by running of software for executing the functions in the embodiment of the present document on a smart terminal.

Herein, in practical application, the mapping unit 52 in the server may be implemented by a Central Processing Unit (CPU), a Digital Signal Processor (DSP) or a Field-Programmable Gate Array (FPGA) in the server. In practical application, the first communication unit 51 and the pushing unit 53 in the server may be implemented by a transceiver or a transceiver antenna in the server.

An embodiment of the present document also provides a client. FIG. 6 is a schematic diagram of a composition structure of a client according to an embodiment of the present document. As shown in FIG. 6, the client includes: a detection unit 61 and a second communication unit 62.

The detection unit 61 is arranged to detect that user information is updated, and acquire information change content.

The second communication unit 62 is arranged to send user information change data to a server, herein the user information change data includes the information change content acquired by the detection unit 61.

According to a further alternative embodiment of the present document, the second communication unit 62 is further arranged to: send a request message corresponding to the group to a target object in the at least one group according to at least one pre-stored group, herein the request message is used for obtaining confirmation of the target object; and is further configured to receive a confirmation message sent by the target object, the confirmation message includes a key corresponding to the target object.

According to a further alternative embodiment of the present document, the second communication unit 62 is further arranged to synchronize information data to the server before detecting that the user information is updated; herein the information data includes at least one piece of group data, and each piece of group data includes a mapping relation between user information categories corresponding to a group and target objects, and a key corresponding to each target object.

According to a further alternative embodiment of the present document, the client further includes an operation processing unit 63.

The second communication unit 62 is further arranged to: receive prompt information, the prompt information is used for representing that there is no group corresponding to the information change content in the server; and is further arranged to send a response message to the server.

The operation processing unit 63 is arranged to: create a group corresponding to the information change content according to a user operation, and trigger the second communication unit 62 to send the response message to the server; the response message includes group data corresponding to the information change content; or, is arranged to trigger the second communication unit 62 to send the response message to the server, the response message is used for indicating not executing any operation.

Those skilled in the art shall understand that functions of each processing unit in the client of the embodiment of the present document may be interpreted with reference to related descriptions for the above-mentioned information sharing method. Each processing unit in the client of the embodiment of the present document may be implemented by means of an analog circuit for achieving the functions in the embodiment of the present document, or may be implemented by running of software for executing the functions in the embodiment of the present document on a smart terminal.

Herein, in practical application, the detection unit 61 and the operation processing unit 63 in the client may be implemented by a CPU, a DSP or an FPGA in the client respectively. In practical application, the second communication unit 62 in the client may be implemented by a transceiver or a transceiver antenna in the client.

An embodiment of the present document also provides an information sharing system. FIG. 7 is a schematic diagram of a composition structure of an information sharing system according to an embodiment of the present document. As shown in FIG. 7, the system includes: a client 60 and a server 50.

The client 60 is arranged to detect that user information is updated, acquire information change content, and send user information change data to the server 50; herein the user information change data includes the information change content;

The server 50 is arranged to receive the user information change data, determine the information change content, inquire at least one pre-stored group according to the information change content, determine that a group corresponding to the information change content exists, obtain information about a target object of the group, and send the information change content to the target object.

According to a further alternative embodiment of the present document, the client 60 is further arranged to synchronize information data to the server before detecting that the user information is updated; herein the information data includes at least one piece of group data, and each piece of group data includes a mapping relation between user information categories corresponding to a group and target objects, and a key corresponding to each target object.

The server 50 is further arranged to receive the information data synchronized by the client 60; herein the information data includes at least one piece of group data, and each piece of group data includes a mapping relation between user information categories corresponding to a group and target objects, and a key corresponding to each target object.

According to a further alternative embodiment of the present document, the client 60 is further arranged to: send a request message corresponding to the group to the target object in the at least one group according to the at least one pre-stored group before detecting that the user information is updated, herein the request message is used for obtaining confirmation of the target object; and receive a confirmation message sent by the target object, herein the confirmation message includes a key corresponding to the target object.

According to a further alternative embodiment of the present document, the server 50 is further arranged to: send prompt information to the client 60 when determining that there is no group corresponding to the information change content, herein the prompt information is used for representing that there is no group corresponding to the information change content; and, is also arranged to receive a response message sent by the client, and not execute any operation according to the response message; or, re-determine whether a group corresponding to the information change content exists according to information data carried in the response message.

The client 60 is further arranged to: receive the prompt information sent by the server 50, the prompt information is used for representing that there is no group corresponding to the information change content in the server 50; create the group corresponding to the information change content according to a user operation, and send the response message to the server 50, herein the response message includes group data corresponding to the information change content; or, send the response message to the server 50, herein the response message is used for indicating not executing any operation.

Specifically, the server 50 is arranged to send information change content encrypted by using the key corresponding to the target object to the target object.

Specifically, the server 50 is further arranged to determine a corresponding user information category according to the information change content, inquire at least one piece of group data according to the user information category, and determine a group corresponding to the user information category.

Those skilled in the art shall understand that the embodiments of the present document may be provided as a method, a system or a computer program product. Thus, forms of hardware embodiments, software embodiments or embodiments integrating software and hardware may be adopted in the present document. Moreover, a form of the computer program product implemented on one or more computer available storage media (including, but are not limited to, a disk memory, an optical memory and the like) containing computer available program codes may be adopted in the present document.

The present document is described with reference to flow charts and/or block diagrams of the method, the device (system) and the computer program product according to the embodiments of the present document. It will be appreciated that each flow and/or block in the flow charts and/or the block diagrams and a combination of the flows and/or the blocks in the flow charts and/or the block diagrams may be implemented by computer program instructions. These computer program instructions may be provided for a general computer, a dedicated computer, an embedded processor or processors of other programmable data processing devices to generate a machine, such that an apparatus for implementing functions designated in one or more flows of the flow charts and/or one or more blocks of the block diagrams is generated via instructions executed by the computers or the processors of the other programmable data processing devices.

These computer program instructions may also be stored in a computer readable memory capable of guiding the computers or the other programmable data processing devices to work in a specific mode, such that a manufactured product including an instruction apparatus is generated via the instructions stored in the computer readable memory, and the instruction apparatus implements the functions designated in one or more flows of the flow charts and/or one or more blocks of the block diagrams.

These computer program instructions may also be loaded to the computers or the other programmable data processing devices, such that processing implemented by the computers is generated by executing a series of operation steps on the computers or the other programmable devices, and therefore the instructions executed on the computers or the other programmable devices provide a step of implementing the functions designated in one or more flows of the flow charts and/or one or more blocks of the block diagrams.

The above is only the alternative embodiments of the present document and not intended to limit the scope of protection of the present document.

### INDUSTRIAL APPLICABILITY

According to the embodiment of the present document, a server receives user information change data, and determines the information change content; inquires at least one pre-stored group according to the information change content, determines that a group corresponding to the information change content exists, and obtains information about a target object of the group; and sends the information change content to the target object. Thus, related contacts may be automatically informed of changed user information without being informed one by one, thereby saving both time and labor and greatly improving the user experience.

1. An information sharing method, comprising:
receiving, by a server, user information change data, and determining information change content;
inquiring at least one pre-stored group according to the information change content, determining that a group corresponding to the information change content exists, and obtaining information about a target object of the group; and
sending the information change content to the target object.

2. The method according to claim 1, wherein, before the server receives the user information change data, the method further comprises:
receiving information data synchronized by a client; wherein, the information data comprises at least one piece of group data, and each piece of group data comprises a mapping relation between user information categories corresponding to a group and target objects, and a key corresponding to each target object.

3. The method according to claim 2, wherein, sending the information change content to the target object comprises:
sending information change content encrypted by using a key corresponding to the target object to the target object.

4. The method according to claim 2, wherein, inquiring the pre-stored group according to the information change content and determining that the group corresponding to the information change content exists comprise:
determining a corresponding user information category according to the information change content, inquiring at least one piece of group data according to the user information category, and determining a group corresponding to the user information category.

5. The method according to claim 1, wherein, when it is determined that there is no group corresponding to the information change content, the method further comprises:
sending prompt information to the client, wherein the prompt information is used for representing that there is no group corresponding to the information change content; and
receiving a response message sent by the client, and not executing any operation according to the response message; or, re-determining whether a group corresponding to the information change content exists according to information data carried in the response message.

6. The method according to claim 1, further comprising:
detecting, by a client, that user information is updated, and acquiring information change content; and
sending user information change data to a server, wherein the user information change data comprises the information change content.

7. The method according to claim 6, wherein, before the client detects that the user information is updated, the method further comprises:
sending, by the client, according to at least one pre-stored group, a request message corresponding to the group to a target object in the at least one group, wherein the request message is used for obtaining confirmation of the target object; and
receiving a confirmation message sent by the target object, wherein the confirmation message comprises a key corresponding to the target object.

8. The method according to claim 6, wherein, before the client detects that the user information is updated, the method further comprises:
synchronizing, by the client, information data to the server; wherein the information data comprises at least one piece of group data, and each piece of group data comprises a mapping relation between user information categories corresponding to a group and target objects, and a key corresponding to each target object.

9. The method according to claim 6, the method further comprising:
receiving, by the client, prompt information; wherein the prompt information is used for representing that there is no group corresponding to the information change content in the server; and
creating a group corresponding to the information change content according to a user operation, and sending a response message to the server, wherein the response message comprises group data corresponding to the information change content; or, sending a response message to the server, wherein the response message is used for indicating not executing any operation.

10. (canceled)

11. A server, comprising: a first communication unit, a mapping unit and a pushing unit; wherein,
the first communication unit is arranged to receive user information change data, and send the user information change data to the mapping unit;
the mapping unit is arranged to determine information change content according to the user information change data sent by the first communication unit, inquire at least one pre-stored group according to the information change content, determine that a group corresponding to the information change content exists, and obtain information about a target object of the group; and
the pushing unit is arranged to send the determined information change content to the target object obtained by the mapping unit.

12. The server according to claim 11, wherein the first communication unit is further arranged to receive information data synchronized by a client before receiving the user information change data; wherein, the information data comprises at least one piece of group data, and each piece of group data comprises a mapping relation between user information categories corresponding to a group and target objects, and a key corresponding to each target object; and
the mapping unit is further arranged to store the information data received by the first communication unit.

13. The server according to claim 12, wherein, the pushing unit is arranged to send information change content encrypted by using a key corresponding to the target object to the target object obtained by the mapping unit.

14. The server according to claim 12, wherein, the mapping unit is arranged to determine a corresponding user information category according to the information change content, inquire at least one piece of group data according to the user information category, and determine a group corresponding to the user information category.

15. The server according to claim 11, wherein, the first communication unit is further arranged to: send prompt information to the client when the mapping unit determines that there is no group corresponding to the information change content, wherein the prompt information is used for representing that there is no group corresponding to the information change content; and receive a response message sent by the client; and
the mapping unit is further arranged to not execute any operation according to the response message received by the first communication unit; or, re-determine whether a group corresponding to the information change content exists according to information data carried in the response message received by the first communication unit.

16. A client, comprising: a detection unit and a second communication unit, wherein,
the detection unit is arranged to detect that user information is updated, and acquire information change content; and
the second communication unit is arranged to send user information change data to a server, wherein the user information change data comprises the information change content acquired by the detection unit.

17. The client according to claim 16, wherein, the second communication unit is further arranged to: send a request message corresponding to the group to a target object in the at least one group according to at least one pre-stored group, wherein the request message is used for obtaining confirmation of the target object; and, is further arranged to receive a confirmation message sent by the target object, wherein the confirmation message comprises a key corresponding to the target object.

18. The client according to claim 16, wherein, the second communication unit is further arranged to synchronize information data to the server before detecting that the user information is updated; wherein the information data comprises at least one piece of group data, and each piece of group data comprises a mapping relation between user information categories corresponding to a group and target objects, and a key corresponding to each target object.

19. The client according to claim 16, further comprising an operation processing unit; wherein,
the second communication unit is further arranged to: receive prompt information, wherein the prompt information is used for representing that there is no group corresponding to the information change content in the server; and, is further arranged to send a response message to the server; and
the operation processing unit is arranged to: create a group corresponding to the information change content according to a user operation, and trigger the second communication unit to send the response message to the server, wherein the response message comprises group data corresponding to the information change content; or, is arranged to trigger the second communication unit to send the response message to the server, wherein the response message is used for indicating not executing any operation.

20. An information sharing system, comprising: a client and a server according to claim 11; wherein,
the client is arranged to detect that user information is updated, acquire information change content, and send user information change data to the server; wherein, the user information change data comprises the information change content.

21-25. (canceled)

26. A computer storage medium, storing computer-executable instructions, wherein the computer-executable instructions are used for executing the information sharing method according to claim 1.

27. (canceled)
